(19) United States
(12) Patent Application Publication
(10) Pub. No.: US 2004/0181575 A1
(43) Pub. Date: Sep. 16, 2004

(54) Method and apparatus for providing peer-to-peer push using broadcast query

(75) Inventors: Terry Mallberg, St. Paul, MN (US); Brian Rhodes, Minneapolis, MN (US)

Correspondence Address: ALTERA LAW GROUP, LLC, 6500 CITY WEST PARKWAY, SUITE 100, MINNEAPOLIS, MN, 55344-7704, US

(73) Assignee: Visual Circuits Corporation, Fridley, MN (US)

(21) Appl. No.: 10/387,255

(22) Filed: Mar. 11, 2003

(51) Int. Cl. G06F 15/16

(52) U.S. Cl. 709/203

(57) ABSTRACT

The present invention provides a peer-to-peer network for pushing data in response to a broadcast query from a content provider. The invention includes broadcasting a query message from a content provider to a plurality of nodes. After the content provider receives a response from at least one of the nodes, the content provider establishes peer-to-peer connections with the responding nodes. The content provider can then push data to the requesting nodes.

### BACKGROUND OF THE INVENTION

1. Field of the Invention

The present invention relates to pushing data in a peer-to-peer network. More particularly, the present invention relates to a method and apparatus for pushing data in a peer-to-peer network to broadcast queried users.

2. Description of Related Art

Communications networks enable vast numbers of persons to communicate virtually limitless amounts of information across great distances. Typically, most of today's Internet and virtually all-corporate communication networks operate using a client/server model to transfer information. In the client/server model all information has to funnel through a central server. The central server, then, controls the operations on the network. It's also a potential processing bottleneck, security risk, and privacy violator.

When a central server is bypassed, control passes back to individual users, enabling new ways of computing and communication. Peer-to-peer (P2P) networks connect computers directly to each other, allowing the sharing messages, files, processing power, storage space, etc. Hence, the Internet becomes the ultimate peer-to-peer mechanism by which services and information can be mutually exchanged and users can easily reach and interact with virtually any computer.

The development of the World Wide Web (WWW, or sometimes referred to as “the web”) has enabled persons with relatively little technical training to find and display information using a browsing device, such as a personal computer or television set-top box (STB), running a browser program. As a result, the number of sites and the number of users on the Internet have grown tremendously.

Connecting users with information is one of the biggest issues that both corporations and content providers face today, especially as data increases, in both value and file size, and as target users grow. Hence, data delivery networks are needed to bring data to users rapidly.

Pull technology refers to when a user receives information only when the user requests information. Typically, this request is performed when the user positions a cursor over a hypertext link that usually appears as highlighted text on a Web page. The text itself is called the anchor of the hypertext link and can be embedded in elements such as lists and tables. Clicking on the highlighted text or an image activates hypertext links. The link may be to a point in the text on the same page, to a new Web page, or to some other object or resource on a network. However, if a user is consistently mining the Web in search of relevant information, the experience is not only frustrating but can be a time-consuming task.

The introduction of push technology brings information directly to users of interest rather than the users having to fetch the data of interest themselves. Thus, push technology overcomes the limitations of the pull model. Push technology is very attractive because it allows users to get information as soon as the information becomes available. Users need not have any knowledge about when information becomes available. Typical applications include news release, press distribution, software distribution, collaborative working group, interactive games, delivering company information to remote monitors, etc.

Nevertheless, there are still some problems with current push technology. For example, a content provider cannot coordinate and control what is being displayed on a user terminal at any instant of time. Accordingly, push technology can deliver a lot of unwanted and unscheduled information to the user or target location.

It can be seen that there is a need to provide push technology in peer-to-peer networks that is controllable by the content provider.

It can also be seen then that there is a need to provide a broadcast query to locate users in the peer-to-peer network.

### SUMMARY OF THE INVENTION

To overcome the limitations in the prior art described above, and to overcome other limitations that will become apparent upon reading and understanding the present specification, the present invention discloses a method and apparatus for pushing data in a peer-to-peer network to broadcast queried users.

The present invention solves the above-described problems by pushing data only to nodes that respond to a broadcast query transmitted from a content provider using a peer-to-peer (P2P) connection between the nodes and the content provider. Further, the present invention solves the above-described problems by providing control of scheduled information. Pushing the information over such connection, and providing control of the information avoid unrequested information, excessive bandwidth utilization, and both source and network overloading.

A method of pushing data in a peer-to-peer network in accordance with the principles of the present invention includes transmitting a query message from a first device to at least one remote device, the query message being used to determine whether the at least one remote device is interested in communicating with the first device, receiving at the first device a response to the query message sent from the at least one remote device, establishing a connection between the first device and the at least one responding remote device based on the response to the query message and pushing data from the first device to the at least one responding remote device.

In another embodiment of the present invention, a method of pushing data via a peer-to-peer network is provided. The method includes transmitting a query message from a first node, receiving at the first node a response message to the query message and pushing data from the first node in reply to the response message.

In another embodiment of the present invention, a method of receiving data pushed via a peer-to-peer network is provided. The method includes receiving a query message at a node, transmitting by the node a response to the query message and receiving at the node pushed data in reply to the response.

In another embodiment of the present invention, a peer-to-peer communication system for pushing data is provided. The system includes a first node for transmitting a query message, the query message being used to determine whether a node remote to the first node is interested in receiving data from the first node and a second node for transmitting a reply message to the query message; wherein the first node pushes data to the second node via a peer-to-peer connection in response to the reply message.

In another embodiment of the present invention, a node for pushing data is provided. The node includes at least one transmitter for transmitting a query message and at least one receiver for receiving a reply message in response to the query message, wherein the transmitter pushes data in response to the reply message.

In another embodiment of the present invention, a node for receiving pushed data is provided. The node includes at least one receiver for receiving a query message and at least one transmitter for transmitting a reply message in response to the query message, wherein the receiver receives pushed data in response to the reply message.

In another embodiment of the present invention, another node for pushing data is provided. This node includes means for transmitting a query message from a node for establishing peer-to-peer communication in a network, at least one means for transmitting a query message and at least one means for receiving a reply message in response to the query message, wherein the means for transmitting pushes data in response to the reply message.

In another embodiment of the present invention, another node for receiving pushed data is provided. This node includes at least one means for receiving a query message and at least one means for transmitting a reply message in response to the query message, wherein the means for receiving receives pushed data in response to the reply message.

In another embodiment of the present invention, a peer-to-peer communication system for pushing data is provided. The peer-to-peer communication system includes at least one first means for transmitting a query message, the query message being used to determine whether a node is interested in receiving data from the at least one content server and at least one second means for transmitting a reply message to the query message, wherein the at least one first means pushes data to the at least one second means via a peer-to-peer connection in response to the reply message.

In another embodiment of the present invention, a program storage device readable by a computer is provided. The A program storage embodies one or more programs of instructions executable by the computer to perform a method of pushing data in a peer-to-peer network, wherein the method includes transmitting a query message from a first device to at least one remote device, the query message being used to determine whether the at least one remote device is interested in receiving data from the first device, receiving at the first device a response to the query message sent from the at least one remote device, establishing a connection between the first device and the at least one responding remote device based on the response to the query message and pushing data from the first device to the at least one responding remote device.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a data delivery system;

FIG. 2 illustrates a hardware environment for establishing peer-to-peer push connections according to the present invention;

FIG. 3a illustrates an embodiment of peer-to-peer pushing for multiple networks using push technology via the Internet according to the present invention;

FIG. 3b illustrates an embodiment of peer-to-peer pushing for multiple nodes using push technology according to the present invention;

FIG. 4 illustrates a schedule for playing media files according to the present invention;

FIG. 5 illustrates a system for pushing data in a peer-to-peer network according to the present invention;

FIG. 6 illustrates a system for receiving pushed information in a peer-to-peer network according to the present invention;

FIG. 7 illustrates the signaling between nodes in a peer-to-peer push configuration according to the present invention;

FIG. 8 is a flow chart illustrating a push of data in a peer-to-peer configuration according to the present invention; and

FIG. 9 illustrates a system according to the present invention.

### DETAILED DESCRIPTION OF THE INVENTION

In the following description of the exemplary embodiment, reference is made to the accompanying drawings, which form a part hereof, and in which is shown by way of illustration the specific embodiment in which the invention may be practiced. It is to be understood that other embodiments may be utilized as structural changes may be made without departing from the scope of the present invention.

The present invention provides a method and apparatus for pushing data in a peer-to-peer network to broadcast queried users. Data is pushed only to nodes that respond to a broadcast query transmitted from a content provider using a peer-to-peer (P2P) connection between the nodes and the content provider. Further, control of scheduled information is provided. Pushing the information over such connection, and providing control of the information avoid unrequested information, excessive bandwidth utilization, and both source and network overloading.

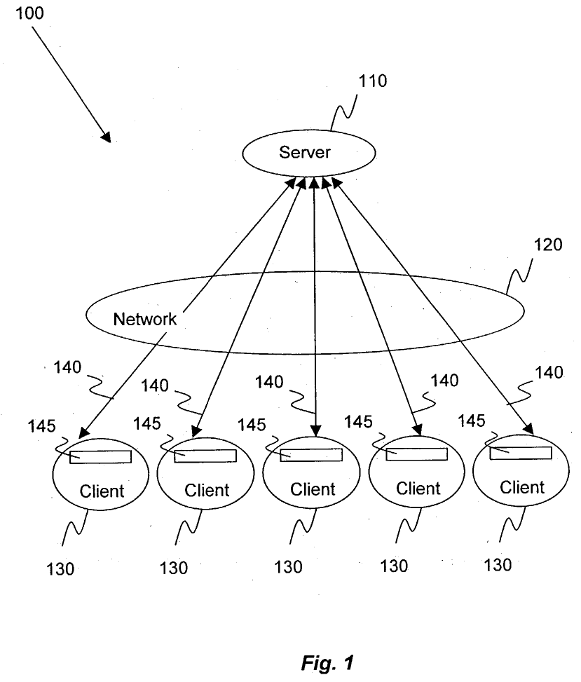

FIG. 1 illustrates a data delivery system 100. Traditional information retrieval applications are based on a client/server model 100. In FIG. 1, a plurality of clients 130 are coupled to the server 110 via bi-directional data connections 140. The clients 130 may be coupled directly to server 110 via the bi-directional data connections 140, or alternatively, the clients 130 may use the bi-directional data connections 140 to traverse a network or the Internet 120. In addition, each of the clients 130 may also include a servicing device 145 to aid in traversing the network or the Internet 120, e.g., a browsing devices, a streaming media server, video server, etc.

Data can be stored on a remote server 110 and may be transmitted to the clients 130. Using a push technology, clients 130 do not have to fetch the data. Rather, the push technology allows a prearranged transmission of the data to the clients 130 over the network 120. The use of push technology allows a server 110 to push its information in some cases without requiring anything on the clients' 130 end but a Web browser and an Internet connection.

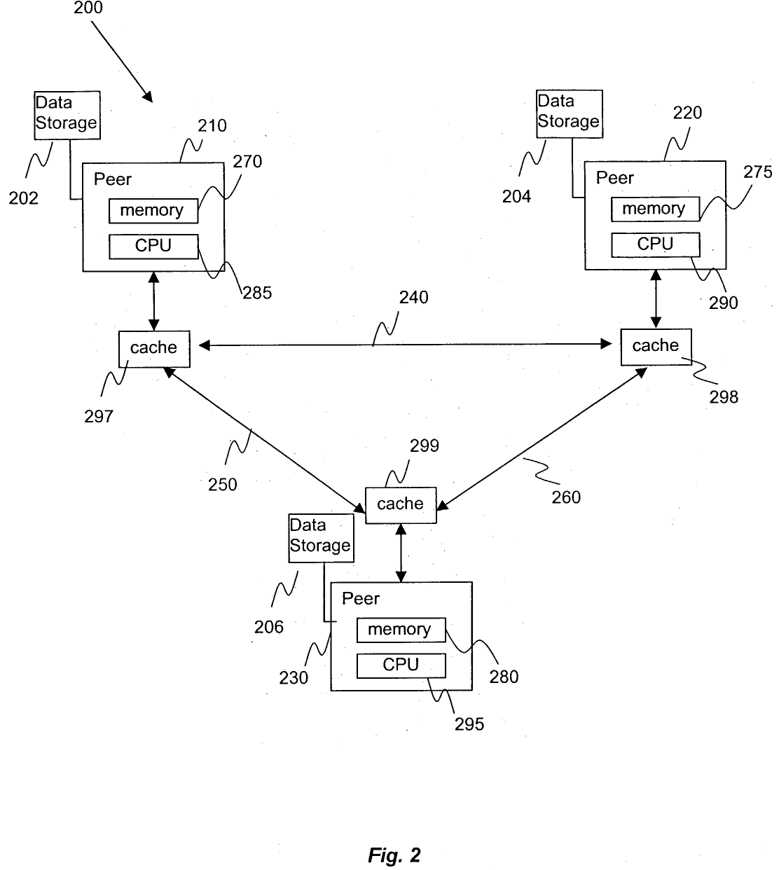

FIG. 2 illustrates a hardware environment 200 for establishing peer-to-peer push connections according to the present invention. Peer-to-peer (P2P) computing allows computers 210-230 (nodes)—and more specifically, their users—to share files and other data directly, without going through a central server (FIG. 1, 110).

One benefit of a P2P network 200 is the complete elimination of the additional server that may cause bottlenecking. The additional server is typically located, for example, between a first peer node 210 and a second peer node 220. The elimination of the additional server not only reduces hardware costs, it also eliminates the server as a potential point of failure. Hence, peer-to-peer connections 240-260 allow the exchanging of information and services directly between nodes 210-230, e.g., between a content provider (e.g., peer 220) and a consumer (e.g., peer 210) of such information.

In the peer-to-peer push configuration of FIG. 2, nodes 210-230 are theoretically interchangeable. That is, each peer 210-230 of the peer-to-peer configuration can act as a content provider or a receiver of the services. However, for the following discussion, node 220 will be referred to as the content provider. Also, each peer 210-230 includes memory 270-290, a central possessing unit (CPU) 285-295, data storage 202-206 and a cache 297-299.

A node 210 that requests information, or alternatively, chooses to subscribe to specific services of the content provider 220, typically will have minimal, or no control of the processes of the content provider 220 that is pushing data to the node 210. However, the node 210 may be configured to dynamically request a change of the pushed data or updates to previously received data.

In one embodiment according to the present invention, data subsequently transmitted by the content provider 220 and received by a node 210, may be stored in the node's memory 270 and executed by the node 210 when desired. In another embodiment, the node 210 that has the capability to do so may execute the data immediately. In yet another embodiment, a content provider 220 may push data to a cache location 297. The node 210 can then pull the data from that cache location 297.

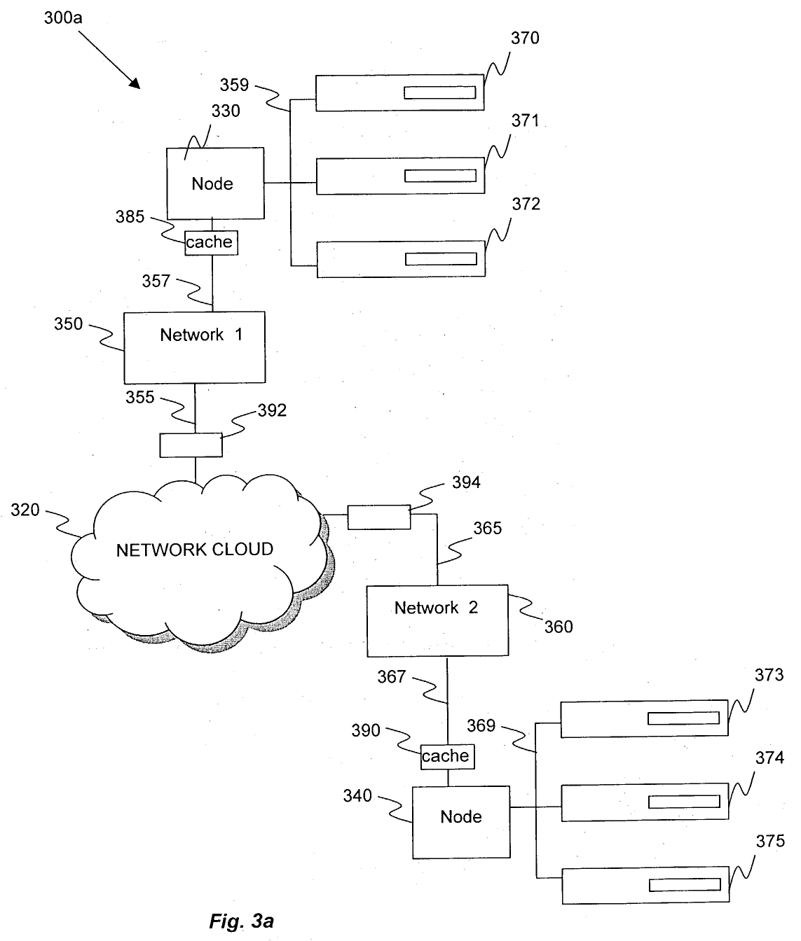

FIG. 3a illustrates an embodiment of peer-to-peer pushing for multiple networks 300a using push technology via the Internet-according to the present invention. In the configuration of FIG. 3, the nodes are theoretically interchangeable. That is, each peer node 330, 340 of the peer-to-peer configuration can act as a content provider or a receiver of the services. However, for the following discussion, node 330 will be referred to as the content provider.

In one embodiment for a push content provider 330, all of the data that the node 340 might wish to view in the devices 373-375 of the node 340 is provided to the node 340. In this way, the data is readily available to the devices 373-375 of the node 340 (and devices 370-372 of the content provider 330). In another embodiment for a push content provider 330, complicated discovery process (e.g., of nodes) in a multitude of complex networks is reduced.

According to the present invention, with regard to FIG. 3, the content provider 330 may be a computer that provides a push service. The content provider 330 is connected to the network cloud 320 (e.g., WAN, Internet, Virtual Private Network (VPN), etc.), e.g., via a connection device 392 such as a router. However, the present invention is not limited to a P2P network coupled by the Internet, but rather may also include a P2P network that is coupled wirelessly, by Ethernet cable, by T1 lines, etc.

Information stored on compact disk (CD), DVD, magneto-optical disks or other form of media, inserted in a content provider 330, may be transmitted to a node 340. Cache servers 385, 390 may be connected between nodes 330, 340, as shown, or may be part of the nodes 330, 340 themselves. In secure networks, the networks 350, 360 may be connected to the network cloud 320 through a connection device 392, 394, such as a gateway. The connection device 392,394 may include a firewall and may be coupled to a cache server (not shown) that is located outside the “firewall” (e.g., on the Internet side and not, for example, on the corporate or personal network side).

Data may also be pushed over any number of networks 350, 360 via established peer-to-peer connections 355-359, 365-369. The established connection may include multiple “one-to-one” connection, “one-to-many” connection, or “many-to-many” connection.

FIG. 3b illustrates an embodiment of peer-to-peer pushing for multiple nodes 300b using push technology according to the present invention. In the configuration of FIG. 3b, the nodes 301-304 are theoretically interchangeable. That is, each peer node 301-304 of the peer-to-peer configuration can act as a content provider or a receiver of the services. However, for the following discussion, node 301 will be referred to as the content provider.

In accordance with the present invention, each node 301-304 may broadcast (or use any other method of transmission, such as multicast and transfer control protocol/internet protocol (TCP/IP)) a query message over a connection 305. When a query is transmitted using multicast, a receiving node may receive information without a need to respond to the content provider 301. In contrast, when a query is transmitted using TCP/IP, a response message is typically required from the receiving node 302-304.

For example, a node 302-304 that is executing application software responsive to such a query and which desires to receive information from the content provider 301 may respond to the content provider's query by connecting to the content provider 301. The node 302-304 will then open a connection 306 and notify the content provider 301 of the node's port to allow the content provider 301 to established a connection to the node 302-304. The content provider 301 will then push information to the node 302-304. This procedure eliminates unrequested data to the node 302-304, extraneous signaling and therefore reduces bandwidth utilization.

With respect to the data created by the push content provider 301, every time an updated file/data or additional playlist (i.e., group of media) is generated, the updated data is transmitted to the nodes 302-304, wherein the nodes 302-304 can update the previous file/data or add the additional playlist to memory or to a schedule, respectively. Accordingly, for example, the new file may merely be a newer version without overwriting the old file or replacing the old file or playlist. When a push content provider 301 discards a file, a message is sent to the node 302-304 to discard the corresponding file. In connection with files created by others and adopted, so to speak, by the push content provider 301, the content provider 301 checks the source of the files at some selected regularity and updates the node 302-304 (or the node's cache servers) appropriately.

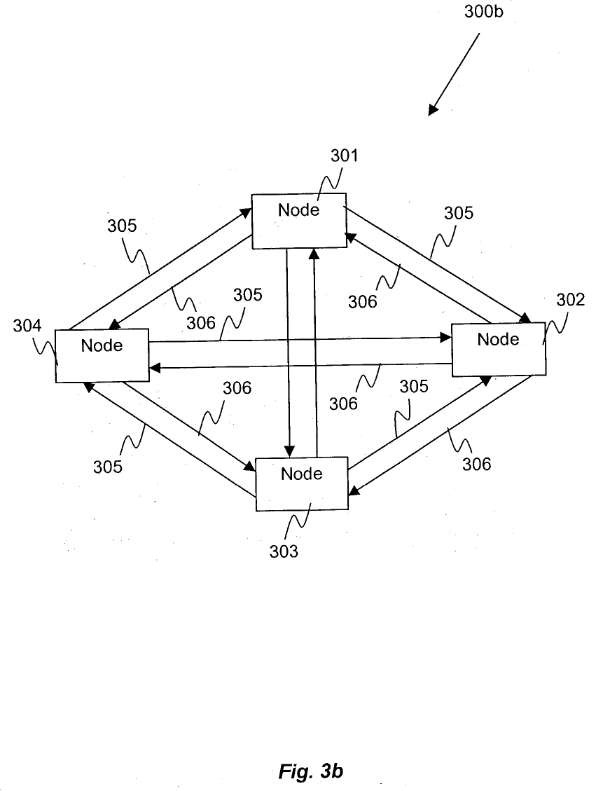

FIG. 4 illustrates a schedule 400 for playing media files according to the present invention. A content provider pushes various information to a node. For example, a schedule 400 for listing files to be executed may be pushed by the content provider. A schedule 400 is composed of one or more events 410. An event 410, for example, may include a playlist 420 and adjustable properties 430-480. The playlist 420 is essentially a group of media arranged in a particular sequence. A playlist file, for example loop3.fpl 490, may include assorted video clip files, graphic overlay files, static image files, voice segment files, multimedia, computer generated graphics, etc, such as FOOD.MP2, IRONMAN.MP2 or ANIMAL SAFARI.MPG. This media can be executed on players 370-375. The adjustable properties may include start and stop times (or start dates) of the media to be executed 430-440, days of the week 450, interrupts 460, single or repetitive play 470, intervals 480, and other properties. However, the invention is not limited to these properties.

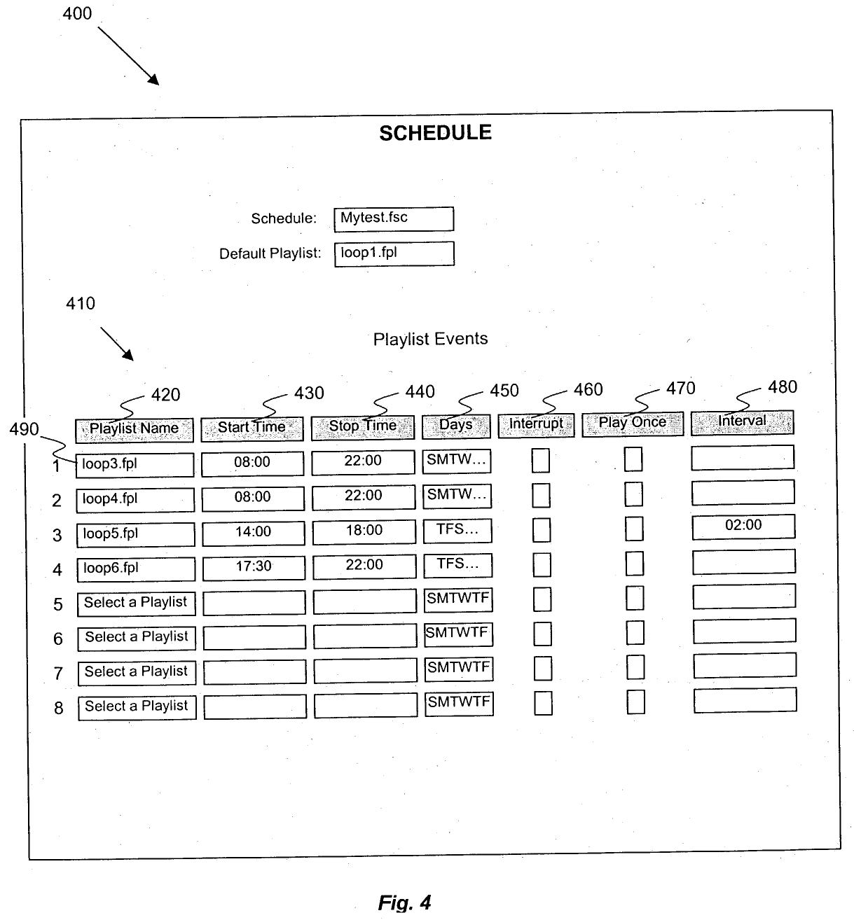

FIG. 5 illustrates a system 500 for pushing data in a peer-to-peer network according to the present invention. The system 500 includes at least one content provider 510 for pushing data. Each content provider includes at least one transmitter 520 for transmitting information such as query messages and data via an output 530. Also, the content provider 510 includes at least one receiver 550 for receiving data via an input 540, e.g., for receiving a response to the query message. In response to the query message, data may then be pushed from the content provider 510.

The content provider 510 may be coupled to at least one data storage device 560. The data storage device 560 may be used to receive or store data and other information, commands, applications, etc. that are use in the operation of the system 500.

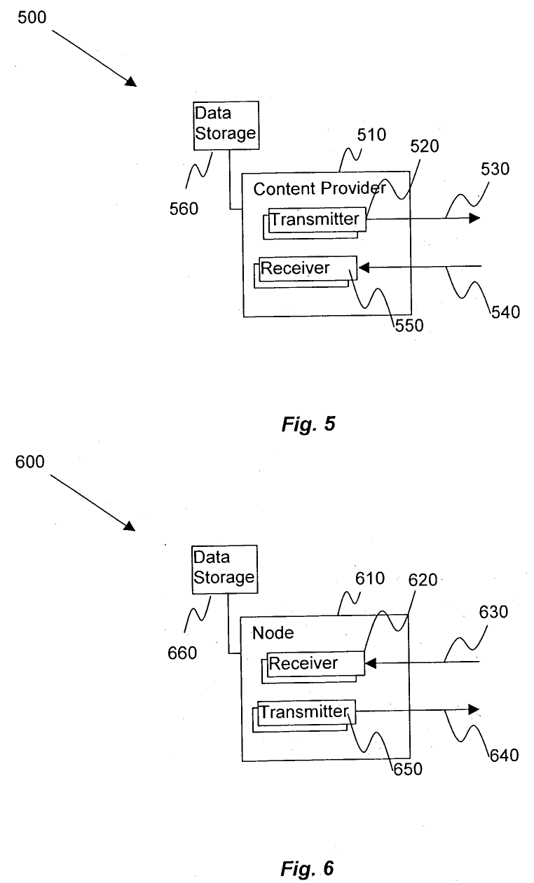

FIG. 6 illustrates a system 600 for receiving pushed information in a peer-to-peer network according to the present invention. The system 600 includes at least one node 610 for receiving pushed information. The node 610 further includes at least one receiver 620 for receiving data, such as a broadcast query message and data via an input 630. Also, the node 610 includes at least one transmitter 650 for responding, for example, to the broadcast query message via an output 640. In the system 600, data is received by at least one node 610, e.g., in reply to a response message transmitted by the node 610.

The node 610 may be coupled to at least one data storage device 660. The data storage device may be used to receive or store data and other information, commands, applications, etc. that are use in the operation of the node 600.

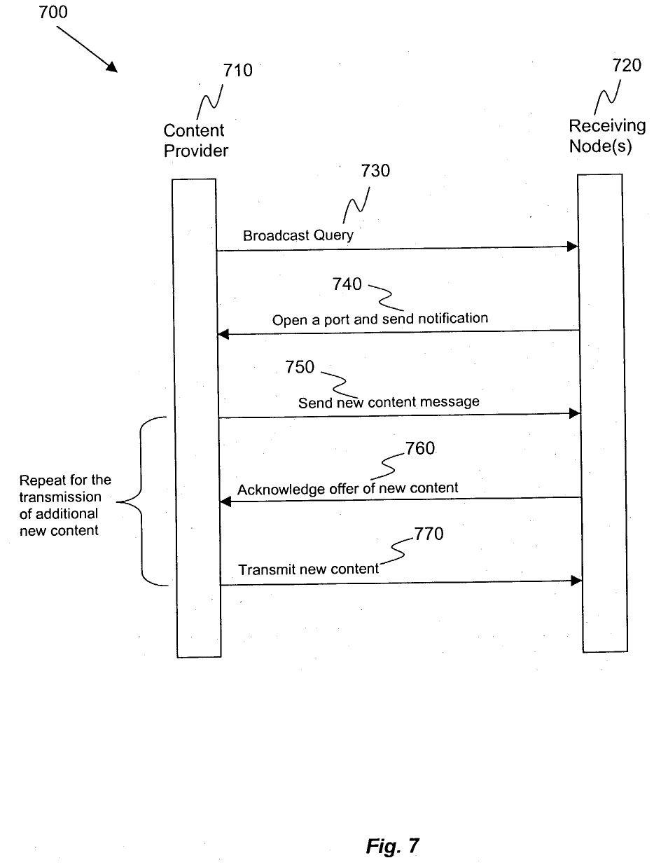

FIG. 7 illustrates the signaling between nodes in a peer-to-peer push configuration 700 according to the present invention. For simplicity, FIG. 7 illustrates only two nodes, a content provider 710 and a receiving node 720, each node having equivalent capabilities and responsibilities. However, the present invention is not limited to two nodes.

According to the present invention, signaling between nodes may be accomplished in the following manner. A content provider 710 in a peer-to-peer network broadcasts a query message over a network 730. However, the present invention is not limited to broadcasting, and hence, other transmission processes such as multicasting and TCP/IP can be used to transmit the query message. The query message may include, but is not limited to, the TCP/IP listen address and port of the content provider 710. A node 720 that is executing application software for data retrieval can receive the query from the content provider 710.

When a receiving node 720 receives the broadcast query message, the receiving node 720 connects to the address and port indicated in the query message. The node 720 then notifies 740 the content provider 710 as to the listen address and port of the node 720. However, the present invention is not limited to this notification. The content provider 710 receives the listen address and port from the node 720 and connects to the port. Bi-directional links are established, for example, as illustrated in FIG. 3b.

When the content provider 710 wants to offer content for any reason (e.g., when a new compact disk having content is detected), the content provider 710 will send a new content message on each of its outgoing channels 750.

When a receiving node 720 receives the new content message, the receiving node 720 will examine the content type. The content type may be determined by: the node providing content, by looking at the file type (playlist or schedule), or if a playlist or schedule has already been received, by checking the already received playlist or schedule for its required content.

If the receiving node 720 wants the content found in the new content message, the receiving node 720 will acknowledge the offer 760. The content provider 710 will receive this acknowledgement and, depending on the transport mode (TCP/IP, multicasting) will transmit new content 770 to the receiving node 720. In the case of multicasting, the content provider 710 will wait for a period of time to allow for a detection of any acknowledgements from the receiving node 720. Hence giving receiving node 720 a chance to listen and acknowledge. If the content provider 710 in the waiting period has detected any acknowledgements, new content will be transmitted to the receiving node 720. In another case, a data connection to the receiving node 720 will be opened and data is pushed to the receiving node 720.

If multiple content needs to be sent to a receiving node 720, a new content message is sent for each new content offering and the above steps subsequent to transmitting a new content message are repeated.

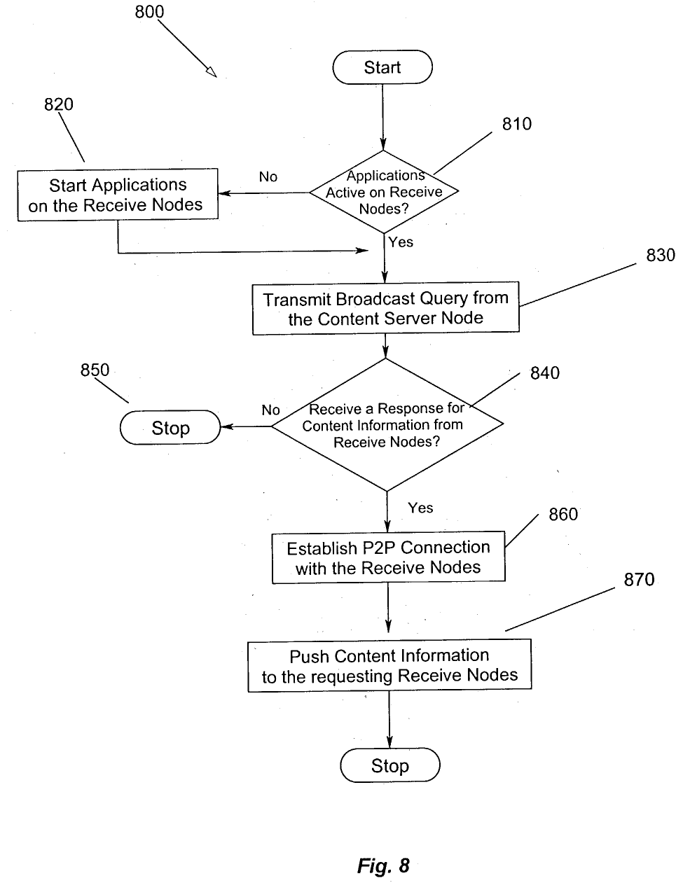

FIG. 8 is a flow chart 800 illustrating a push of data in a peer-to-peer configuration using a broadcast query according to the present invention. Nodes can receive and respond to broadcast queries from a content provider if an application software for query response is running on the individual nodes 810. If the query response software is not running on the individual nodes, each requesting individual node must start their query response software 820. The content provider will broadcast a query over the Internet/network and wait for a response from a node 830. If no response is received 840, the content provider can rebroadcast the query or terminate the broadcast 850.

In the event a response is received from an individual node(s) at the content provider, the content provider will establish a peer-to-peer connection with the node(s) using the node's address parsed from the response message 860. Thereafter, the content provider can push data and/or updates to the node(s) or to cached locations near each node 870.

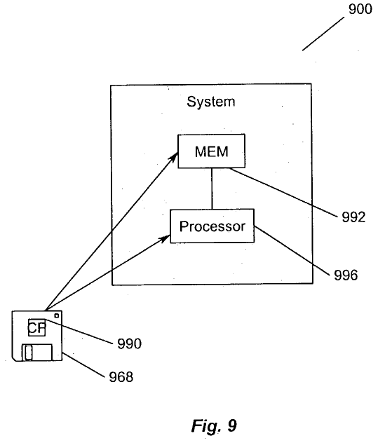

FIG. 9 illustrates a system 900 according to the present invention, wherein the process illustrated with reference to FIGS. 1-8 may be tangibly embodied in a computer-readable medium or carrier, e.g. one or more of the fixed and/or removable data storage devices 968 illustrated in FIG. 9, or other data storage or data communications devices. A computer program 990 expressing the processes embodied on the removable data storage devices 968 may be loaded into the memory 992 or into the system 900, e.g., in a processor 996, to configure the system 900 of FIG. 9, for execution. The computer program 990 include instructions which, when read and executed by the system 900 of FIG. 9, causes the system 900 to perform the steps necessary to execute the steps or elements of the present invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A method of pushing data in a peer-to-peer network, comprising:
transmitting a query message from a first device to at least one remote device, the query message being used to determine whether the at least one remote device is interested in communicating with the first device;
receiving at the first device a response to the query message sent from the at least one remote device;
establishing a connection between the first device and the at least one responding remote device based on the response to the query message; and
pushing data from the first device to the at least one responding remote device.

2. The method of claim 1 wherein the establishing a connection between the first device and the at least one responding remote devices further comprises establishing a peer-to-peer connection between the first device and the at least one responding remote device.

3. The method of claim 1 wherein the transmitting of the query message further comprises broadcasting the query message from the first device to the at least one remote device.

4. The method of claim 1 wherein the pushing of data from the first device to the at least one remote device further comprises pushing a schedule for executing events.

5. The method of claim 4 wherein the executing events further comprises executing media files.

6. The method of claim 4 further comprising adjusting properties for executing the events.

7. The method of claim 1 wherein the pushing of data from the first device to the at least one remote device further comprises pushing media files.

8. The method of claim 1 wherein the pushing of data from the first device to the at least one remote device further comprises pushing data into a memory location of the at least one responding remote device.

9. The method of claim 1 wherein the pushing of data from the first device to the at least one remote device further comprises transmitting data to a cache server coupled to the at least one responding remote device.

10. The method of claim 1 wherein the receiving a response from the at least one remote device further comprises receiving parameters from at least one responding remote device for dynamically changing and/or updating pushed data.

11. The method of claim 10 wherein the receiving parameters from the at least one responding remote device further comprises receiving an address of the at least one responding remote device.

12. The method of claim 1 wherein the receiving a response from at least one remote device further comprises receiving a request to terminate the pushing of data by at least one responding remote device.

13. The method of claim 1 further comprising terminating the connection by the first device.

14. A method of pushing data via a peer-to-peer network, comprising:
transmitting a query message from a first node;
receiving at the first node a response message to the query message; and
pushing data from the first node in reply to the response message.

15. The method of claim 14 wherein the pushing data from the first node further comprises establishing a peer-to-peer connection between the first node and a device sending the response message.

16. The method of claim 14 wherein the transmitting of the query message further comprises broadcasting the query message from the first node.

17. The method of claim 14 wherein the pushing of data from the first node further comprises pushing a schedule for executing events.

18. The method of claim 17 wherein the executing events further comprises executing media files.

19. The method of claim 17 further comprising adjusting properties for executing the events.

20. The method of claim 14 wherein the pushing of data from the first node further comprises pushing media files.

21. The method of claim 14 wherein the receiving at a first node a response message further comprises receiving parameters for dynamically changing and/or updating pushed data.

22. The method of claim 21 wherein the receiving parameters further comprises receiving a target address.

23. The method of claim 14 wherein the receiving a response message further comprises receiving a request to terminate the pushing of data.

24. A method of receiving data pushed via a peer-to-peer network, comprising:
receiving a query message at a node;
transmitting by the node a response to the query message; and
receiving at the node pushed data in reply to the response.

25. The method of claim 24 wherein the receiving at the node pushed data further comprises establishing a peer-to-peer connection between the node!and a device pushing the data.

26. The method of claim 24 wherein the receiving pushed data further comprises receiving a schedule for executing events.

27. The method of claim 26 wherein the executing events further comprises executing media files.

28. The method of claim 26 further comprising adjusting properties for executing the events.

29. The method of claim 24 wherein the receiving pushed data further comprises receiving pushed data into a memory location of the node.

30. The method of claim 24 wherein the receiving pushed data further comprises receiving parameters for dynamically changing and/or updating previously pushed data.

31. A peer-to-peer communication system for pushing data, comprising:
a first node for transmitting a query message, the query message being used to determine whether a node remote to the first node is interested in receiving data from the first node; and
a second node for transmitting a reply message to the query message;
wherein the first node pushes data to the second node via a peer-to-peer connection in response to the reply message.

32. The peer-to-peer communication system of claim 31 wherein the first node establishes a peer-to-peer connection with the second node transmitting a reply message.

33. The peer-to-peer communication system of claim 31 wherein the first node further comprises a transmitter for broadcasting the query message to the second node.

34. The peer-to-peer communication system of claim 31 wherein the second node further comprises a memory location for receiving data.

35. The peer-to-peer communication system of claim 31 wherein the data further comprises a schedule pushed to the second node for executing events.

36. The peer-to-peer communication system of claim 35 wherein the events further comprising media files.

37. The peer-to-peer communication system of claim 35 wherein the data further comprises adjustable properties for the events.

38. The peer-to-peer communication system of claim 31 wherein the reply message further comprises parameters used by the first node for dynamically changing and/or updating pushed data.

39. The peer-to-peer communication system of claim 38 wherein the parameters in the reply message further comprise an address of the second node transmitting a reply message.

40. The peer-to-peer communication system of claim 31 wherein the reply message further comprises a request to terminate parameter for terminating the pushing of data to the responding second node.

41. The peer-to-peer communication system of claim 40 wherein the first node terminates the pushing of data to the responding second node in response to receiving the request to terminate parameter in the reply message.

42. The peer-to-peer communication system of claim 40 wherein the second node terminates a connection between the second node and the first node in response to receiving the request to terminate parameter in the reply message.

43. A node for pushing data, comprising:
at least one transmitter for transmitting a query message; and
at least one receiver for receiving a reply message in response to the query message;
wherein the transmitter pushes data in response to the reply message.

44. The node of claim 43 wherein the transmitter establishes a peer-to-peer connection with a device for receiving the pushed data.

45. The node of claim 43 wherein the transmitter transmits the query message by broadcasting the query message.

46. The node of claim 43 wherein the transmitter transmits a schedule to the at least one node for executing events.

47. The node of claim 43 wherein the query message further comprises parameters for dynamically changing and/or updating pushed data.

48. A node for receiving pushed data, comprising:
at least one receiver for receiving a query message; and
at least one transmitter for transmitting a reply message in response to the query message;
wherein the receiver receives pushed data in response to the reply message.

49. The node of claim 48 wherein the receiver is connected to a device pushing the data using a peer-to-peer connection.

50. The node of claim 48 wherein the receiver receives a schedule for executing events.

51. The node of claim 48 further comprising a memory location for receiving the data.

52. The node of claim 48 wherein the reply message further comprises parameters used for dynamically changing and/or updating data.

53. A node for pushing data, comprising:
means for transmitting a query message from a node for establishing peer-to-peer communication in a network;
at least one means for transmitting a query message; and
at least one means for receiving a reply message in response to the query message;
wherein the means for transmitting pushes data in response to the reply message.

54. A node for receiving pushed data, comprising:
at least one means for receiving a query message; and
at least one means for transmitting a reply message in response to the query message;
wherein the means for receiving receives pushed data in response to the reply message.

55. A peer-to-peer communication system for pushing data, comprising:
at least one first means for transmitting a query message, the query message being used to determine whether a node is interested in receiving data from the at least one content server; and
at least one second means for transmitting a reply message to the query message;
wherein the at least one first means pushes data to the at least one second means via a peer-to-peer connection in response to the reply message.

56. A program storage device readable by a computer, the program storage device tangibly embodying one or more programs of instructions executable by the computer to perform a method of pushing data in a peer-to-peer network, the method, comprising:
transmitting a query message from a first device to at least one remote device, the query message being used to determine whether the at least one remote device is interested in receiving data from the first device;
receiving at the first device a response to the query message sent from the at least one remote device;
establishing a connection between the first device and the at least one responding remote device based on the response to the query message; and
pushing data from the first device to the at least one responding remote device.
